(19) United States
(12) Patent Application Publication
(10) Pub. No.: US 2010/0258096 A1
(43) Pub. Date: Oct. 14, 2010

(54) Intercooler cartridge assembly design for improving internal combustion engine performance

(75) Inventors: Philip Andrew Frank, Portland, OR (US); Steve Mark Saleen, Coto de Caza, CA (US)

Correspondence Address: Martin Karo;SMS Supercars, Inc., 205 Garber Drive, Yardley, PA, 19067, US

(73) Assignee: SMS Supercars, Inc., Yardley, PA (US)

(21) Appl. No.: 12/384,838

(22) Filed: Apr. 9, 2009

(51) Int. Cl. F02B 33/00

(52) U.S. Cl. 123/563

(57) ABSTRACT

A method and design for cooling the temperature of induction air fed into a motor vehicle engine, which includes an intercooler housed in an induction plenum. The intake side of the plenum feeds air compressed by a supercharger or turbocharger to the intercooler core. The intercooler core consists of a series of cooling cylinders, held side by side in an arched arrangement by a rigid cartridge. The use of the multiple cooling cylinders increases the surface area of the intercooler presented to the airstream, and thus the efficiency of the intercooler. The use of a rigid cartridge that contains the cooling cylinders, and fits inside a pair of matching machined end caps which simultaneously hold the cartridge and feed coolant to the intercooler cores, enables efficient assembly of the intercooler. The system design is readily adaptable for various engine conformations.

### CROSS-REFERENCE TO RELATED APPLICATIONS

N/A

### STATEMENT REGARDING FEDERALLY SPONSORED RESEARCH OR DEVELOPMENT

N/A

### Description

### FIELD OF THE INVENTION

The present invention generally relates to an apparatus and method for improving the performance of an internal combustion engine, and, more particularly, to the use of an intercooler to increase the efficiency of a supercharger or turbocharger for an automobile engine.

### BACKGROUND OF THE INVENTION

An internal combustion engine typically sucks in the air and fuel mixture, which is often referred to as charge, needed for driving the engine via the negative pressure generated during the intake strokes. An engine with larger cylinders can take in more charge and, therefore, generate more power. Accordingly, one way of increasing power is to increase engine displacement; however, this requires a larger, heavier motor. A method of increasing engine power which does not require increasing the engine size and weight is to use a compressor in the intake track of the engine to compress the intake air above atmospheric pressure. This air compressor forces more charge into the engine cylinders, thereby increasing the volumetric efficiency of the engine beyond that of a normally aspirated engine without the gas compressor.

An intake gas compressor can be exhaust gas driven or mechanically driven. An exhaust gas driven intake gas compressor is also referred to as a “turbo supercharger,” or, more commonly, as a “turbocharger.” A mechanically driven intake gas compressor is conventionally referred to as a supercharger and is mechanically coupled to the engine crankshaft by a belt, a chain, or a gearbox. A turbocharger is generally smaller than a mechanically driven supercharger and does not draw power off the engine, its propulsion being provided by waste exhaust gases being expelled from the motor. However, while the supercharger provides virtually instant increased response, the delay inherent in the physical process of powering up a turbocharger—increasing engine speed conventionally by feeding additional fuel, the increased engine speed causing the exhaust stream to increase in velocity, thereby increasing the rotational speed of the turbine vanes, thereby increasing compressor power—results in what is commonly referred to as “turbo lag.” The turbo lag associated with a turbocharger often results in a less desirable driving experience, especially in high performance cars.

Both turbochargers and superchargers may be incorporated in the original design of a vehicle powertrain system, or be installed as an aftermarket addition to increase power and/or efficiency. Superchargers tend to be somewhat easier for sports car enthusiasts to install as an aftermarket addition to their otherwise mass-produced cars with normally aspirated engines because the pulley to provide power can be bolted directly to the front of the engine; a turbocharger requires significant redesign of the exhaust system of a normally aspirated engine, as well as the intake system.

A difficulty inherent in the design of any supercharger or turbocharger is caused by the fact that the simple act of compressing the induction air charge heats it. This is elementary physics: under the ideal gas law, pressure times volume divided by temperature is a constant. Therefore, since engine volume remains constant, as the pressure of the induction charge increases, so will its temperature. Higher temperatures decrease the thermal efficiency of the engine. High temperature charge also increases the likelihood of premature intake charge detonation, thereby requiring high octane fuel and negatively impacting the engine life. Accordingly, many supercharger and turbocharger systems incorporate an intercooler, a device that employs an air-to-air or liquid coolant-filled heat exchanger to reduce the temperature of the compressed induction air. Most such systems in vehicle applications rely on flat panels employing thousands of small, thin thermal absorbing fins which surround small coolant-carrying tubes. The compressed air is forced through this panel, giving up some of its heat in the process. However, the panel faces space constraints in the area generally available under an automobile hood, and the need to minimize the size and thus weight of the intercooler housing also restricts the space available for heat absorption surface.

Furthermore, intercoolers require complex air and coolant plumbing. In the restricted space presented under the hood of an automobile, it can be difficult to develop an arrangement of general application which allows a large enough intercooler to be effective and sufficient air flow to be effective. The greater the space required for an intercooler, the more it must be custom-designed to the application, as all vehicles present different space possibilities. Design, assembly and installation can therefore be difficult. This is especially true for aftermarket applications, where the original equipment manufacturer did not make allowances for the air and coolant plumbing required for a compressor and intercooler.

Accordingly, it would be advantageous to develop an intercooler device that is simple to assemble, compact, and which can be readily modified to different applications. It is desirable for the supercharger and intercooler to allow a large airflow of low-temperature compressed air to improve the volumetric efficiency of the engine while increasing power and engine life.

### SUMMARY OF THE INVENTION

It is a general object of the present invention to provide an improved intercooler arrangement for a motor vehicle.

It is another object of the present invention to provide an intercooler core design which presents greater heat absorption surface to reduce the temperature of the air flowing through the core.

It is another object of the present invention to provide an intercooler arrangement that is of compact construction.

It is another object of the present invention to provide an intercooler arrangement that is standardized and readily adaptable to varied applications.

Additional advantages and benefits of the present invention will become apparent to those skilled in the art to which the present invention relates from a reading of the description herein of the illustrated embodiment, the accompanying drawings, and the attached claims.

### BRIEF DESCRIPTION OF THE DRAWINGS

FIG. 1 is an exploded schematic diagram illustrating a perspective view of an intercooler assembly for an internal combustion engine in accordance with an embodiment of the present invention;

FIG. 2 is a schematic diagram illustrating a cross-sectional lateral view of the intercooler assembly and intake runners;

FIG. 3 is a schematic diagram illustrating a perspective view of an intercooler cartridge intended to hold intercooler tubes, in accordance with an embodiment of the present invention;

FIG. 4 is a schematic diagram illustrating a cross-sectional longitudinal view of the intercooler case assembly;

FIG. 5 is a schematic diagram illustrating the flow of coolant through the intercooler in accordance with an embodiment of the present invention.

### DETAILED DESCRIPTION OF THE INVENTION

A preferred embodiment of the present invention is described here, installation of the apparatus between the engine cylinder banks on a V-8 motor. The text below includes references to the figures and descriptions, where elements of similar structures or functions in the text are illustrated by matching reference numerals throughout the figures. It should be noted that the figures are only intended to facilitate the description of the preferred embodiment of the present invention. They are not intended as an exhaustive description of the present invention nor as a limitation on the scope of the present invention. Variations of the preferred embodiment are not only expected, but are intended, and shall be considered to be within the scope of the present invention.

This apparatus and method improves performance for both turbochargers and superchargers. For purposes of description of the invention, the term “supercharger module” shall be used to mean a compressor that may be a supercharger or a turbocharger, it being understood that the preferred embodiment is demonstrated with a supercharger. For purposes of description, the term “intake charge” shall be used to describe the compressed air emitted by the supercharger module, which is ultimately routed into the intake ports of the engine.

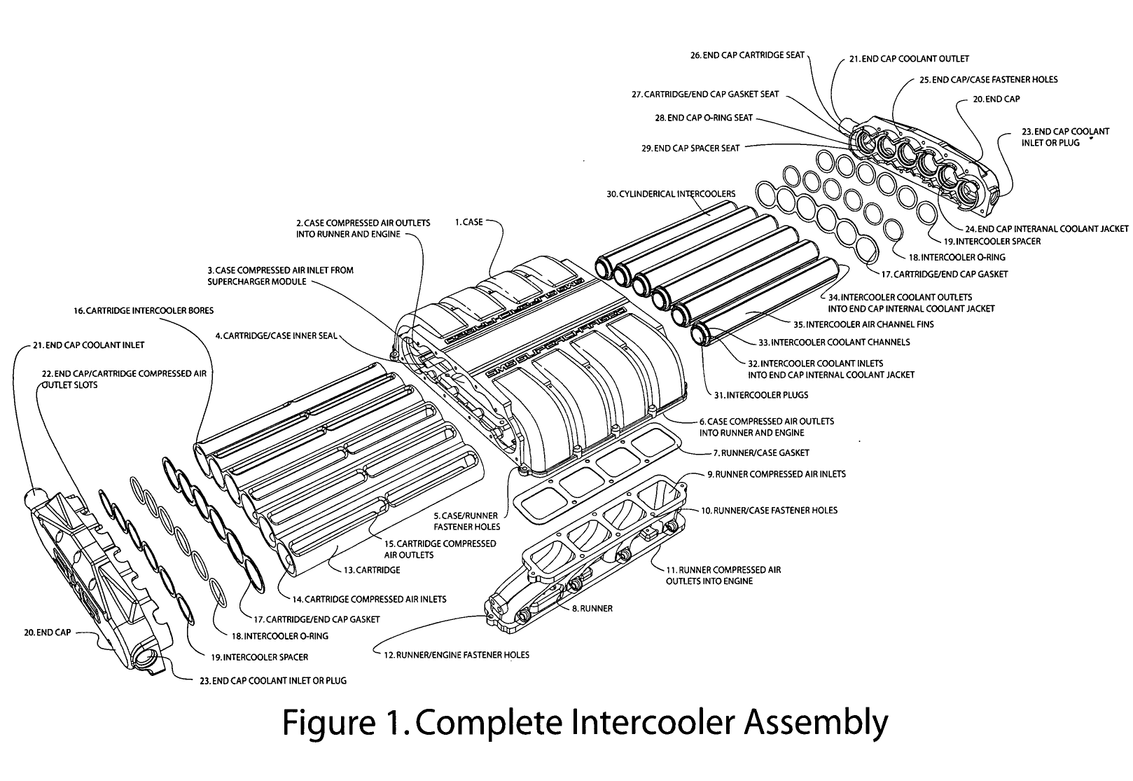

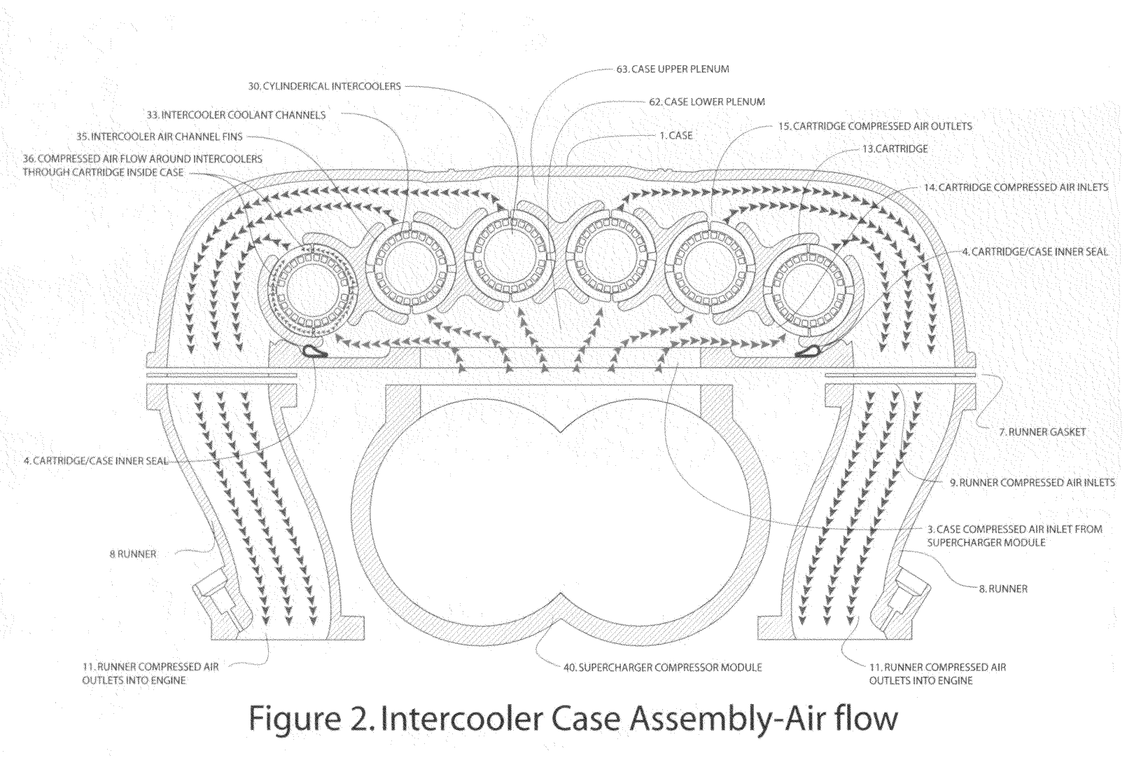

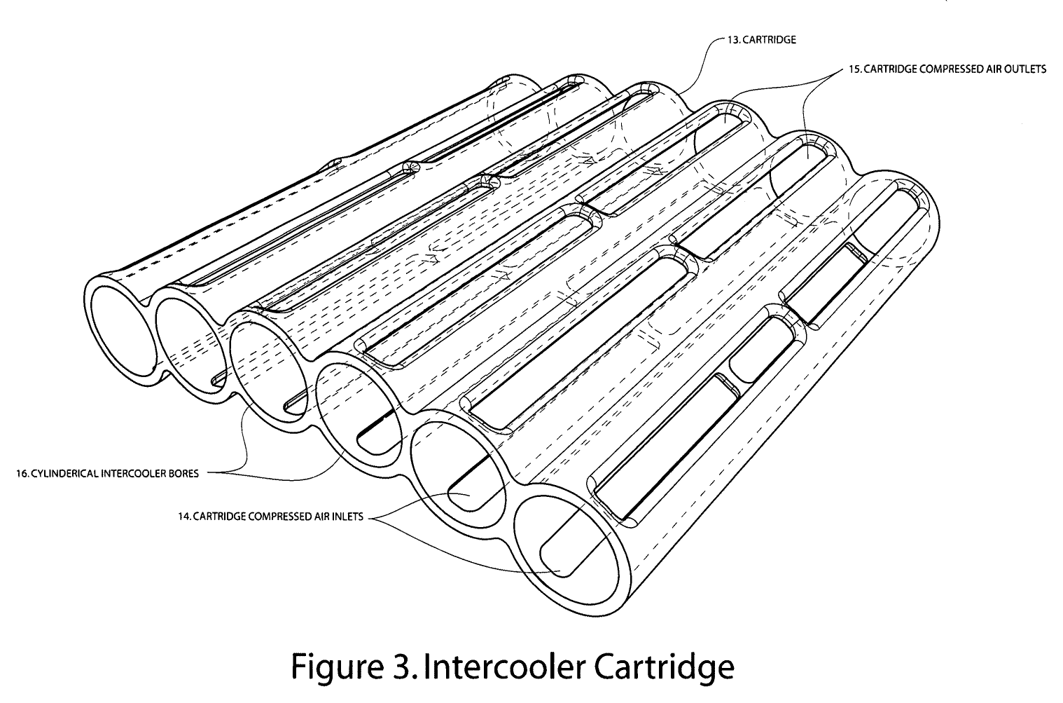

FIGS. 1, 2, 3, 4, and 5 illustrate an apparatus for boosting engine performance in accordance with an embodiment of the present invention. Specifically, the apparatus is a low resistance intercooler, composed of cylindrical intercooler tubes (30) held within a rigid cartridge (13), and the cartridge itself held between two end caps (20) and surrounded by a one-piece case (1). In the preferred embodiment illustrated here, the intercooler feeds air charge into a V-shaped eight cylinder (V-8) engine at its intake ports (61). The casting of the case (1) and runners (8) with a small number of sealing surfaces is beneficial because of its high efficiency and high reliability in maintaining the positive air pressure from the supercharger (40). In the preferred embodiment, the two piece outer casing structure makes the assembled supercharger unit simple, reliable, and easy to maintain. The components, e.g., intercooler cartridge (13), end caps (20), and supercharger module (40) can be easily accessed for maintenance, repair, or replacement by loosening the mechanical fasteners, e.g., bolts that bolt case (1), runners (8), and end caps (20), and removing top piece (1).

The upper intake case (1) provides an air inlet (3) which provides gas communication between the supercharger module (40) and the lower plenum (62). The methods of attachment of the case (1) to the compressor module (40) and the intake runners (8) by means of bolts and gaskets (5, 7, 10), and of the runners to the engine head, are conventional and not within the scope of the present invention.

The intercooler itself is shown in FIG. 1 to feature a series of cylindrical intercoolers (30). [These units are interchangeably referred to herein as “cores”, the designation of which refers to the same part (30).] The cores are hollow for weight reduction, but the ends are plugged (31) to prevent coolant from bypassing the intended passages. The wall of each core (30) is composed of numerous heat exchanging fins (35) extending radially around the core, and numerous coolant channels (33) extending axially the length of each core. Water passes through the core by means of the circulation system discussed below. Such cylindrical intercoolers or cores are commercially available; one source is Laminova of Sweden (see attachment), the supplier whose unit is featured in the preferred embodiment.

The cores are held in a rigid cartridge (13). Referencing generally FIGS. 1, 2, and 3, the cartridge (13) is shaped with a series of cylindrical bores (16), joined side to side in a slightly arched pattern. The preferred embodiment illustrated here includes six. Each cartridge intercooler bore (16) has long intake slots on the lower side (14), and matching outlet slots on the upper side (15). The compressed air from the supercharger/turbocharger module (40) is forced upwards through the intake slots (14), flows around the core (30) heat exchanging fins (35), and out the outlet slots (15). Cartridge inner seals (4) which run the length of the outer lower edges of the cartridge (13) prevent the compressed air from bypassing the intercooler. The cartridge (13) is arched in order to provide additional air space for the lower plenum (62) in a slightly hemispherical orientation which helps equalize compressed charge air distribution across the face of the intercooler.

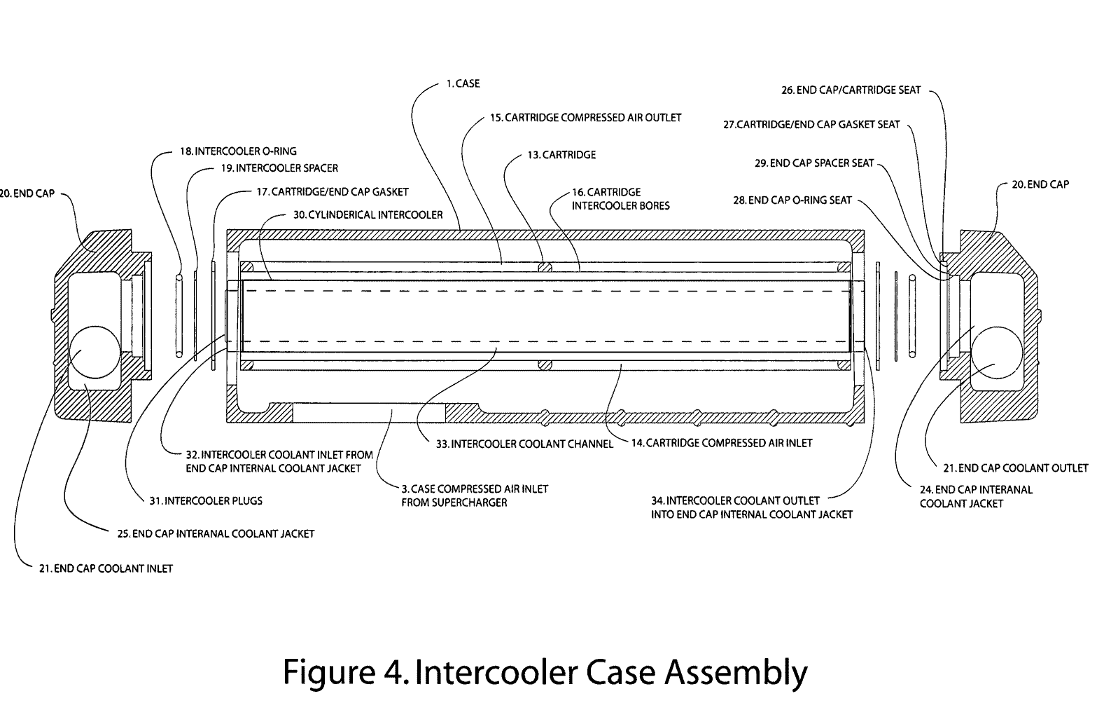

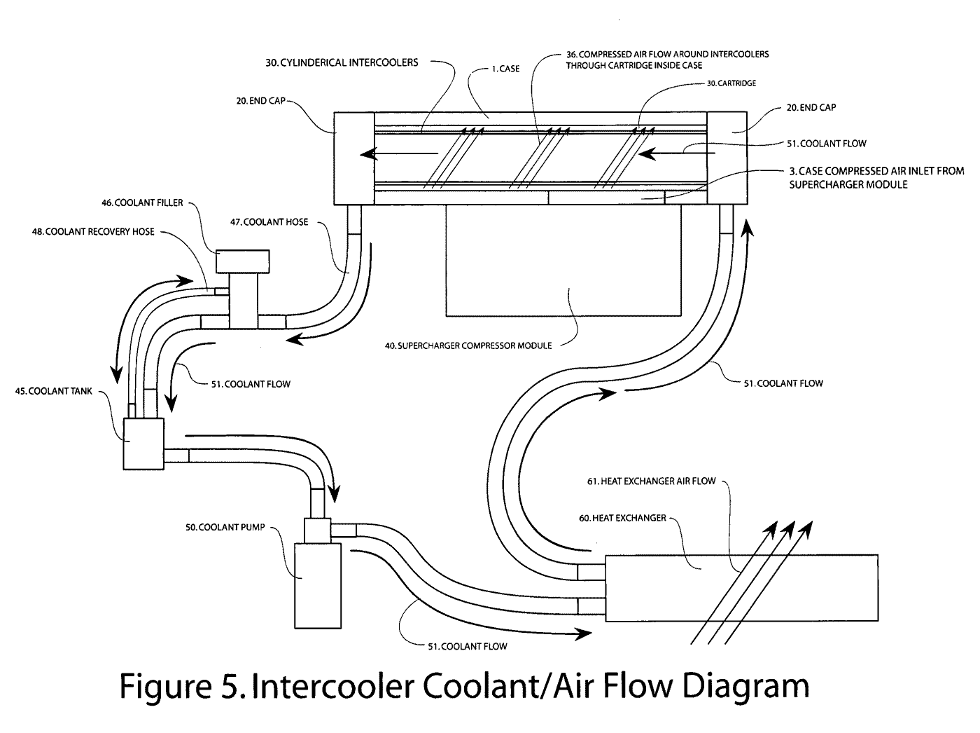

The cartridge (13) with its intercooler cores (30) is contained within the intercooler plenum case (1), and is held rigidly in position and supplied with coolant water by the end caps (20). These are symmetrical, and indeed may be cast as identical pieces. Each end cap (20) contains a cavity or jacket running its width to contain coolant fluid (24, 25), and has circular holes at either end. One hole is closed with a plug (23), the other has a coolant inlet or outlet (21) installed; the orientation of the plug and the outlet of each end cap depend upon the configuration of the water cooling system (FIG. 5). Referencing FIGS. 1 and 4, the end caps (20) are bolted to the intercooler case (1), one at either end. The end caps also form the lateral walls of the lower plenum (62) and the upper plenum (63). The methods of attachment of the end caps (20) to the case (1) by means of bolts (not shown) and threaded bolt holes are conventional and not within the scope of the present invention.

The side of the end cap (20) which faces the cartridge (13) and is bolted to the case (1) has holes bored in it, the size and number of holes matching the size and number of cylindrical intercooler cores (30) and cartridge bores (13). In the preferred embodiment illustrated here, there are six holes. Each hole has a number of seats cut into its rim (26/27, 28, 29), the function of which is described below.

The cartridge and cores are pressed between the end caps and held in position within the case (1) by cutouts in the facing end cap surfaces (FIG. 4). The face of the end cap (20) is machined in a manner that its outer edge mirrors the adjacent outer edge of the case (1). The end of the cartridge (13), which contains each core (30), is held and positioned by a cutout in the face of the end cap which matches the contour of the end of the cartridge (26). The machining of the end cap cartridge seat (26) is such that it provides a flange presenting an outer, “female” mating surface to the end of the cartridge (13). To the extent the cartridge seat (26) overlaps a cartridge compressed air inlet (14) or outlet (15), the seat is cut back with corresponding slots (22). A cartridge/end cap gasket (17) fits into a seat cut into the face of the end cap (27), and is squeezed between the face of the end cap (20) and the outer rim of the cartridge (30), thus containing the compressed charge air within the cartridge (13) and intercooler cores (30). An intercooler spacer (19) fits over each end of each intercooler core (30) and into a seat cut into the facing surface of the end cap (29). This spacer positions the intercooler core (30) to properly receive the coolant water. When so positioned, the coolant inlets and outlets (32, 33) of the intercooler core (30) are in fluid communication with the internal coolant jackets (24, 25) of the end caps (20). A rubber intercooler O-ring (18) fits around each end of each intercooler core (30) and is positioned into a seat cut into the facing surface of the adjacent end cap (28). Plugs (31) are installed in both ends of each core (30) to prevent coolant flow through the hollow centers.

FIG. 5 illustrates schematically a water coolant system dedicated to the intercooler. The direction of coolant flow is indicated by arrows (51). The system plumbing begins with a coolant pump (50) is in fluid communication, through a coolant hose (47), with a heat exchanger (60). The outlet side of the heat exchanger (60) is in fluid communication, via a coolant hose (47), with the end cap coolant inlet (21) of the intercooler case end cap (20). The end cap coolant outlet (21) is in fluid communication, via a coolant hose, with a coolant tank (45). The coolant tank is in fluid communication via coolant hose (47) with the inlet side of the coolant pump (50). A coolant recovery hose (48) is in fluid communication with the coolant tank (45), and a coolant filler (46) is as well.

With this description of the construction of the apparatus, the function of the invention is readily explained. The intake charge from the supercharger module (40) passes through an air inlet (3) and is admitted to the lower plenum (62). The intake charge at that point has been heated from the compression process. The case inner seal (4) and the end caps (20) prevent the intake charge from escaping. The intake charge passes through the air inlets (14) in the intercooler cartridge (13) and flows around the intercooler cylinders (30, 36), giving up excess heat to the intercooler air channel fins (35). The now-cooled intake charge next exits through the cartridge air outlets (15) into the upper plenum (63). The intake charge next flows through the runner air inlets (9) into the intake runners (8), and continues out the runner outlets (11) into the engine intake ports.

The coolant flow is also readily explained in light of the construction description. The direction of coolant flow is indicated by arrows (51). A coolant pump (50) forces coolant to flow through a heat exchanger (60), where the air flow (61) reduces its temperature. The cooled liquid coolant then is piped through the end cap coolant inlet (21) to the end cap internal coolant jacket (25) contained within the end cap (20). Plugs (31) in each cylindrical intercooler tube (30) prevent coolant from flowing through the hollow centers of the cylindrical intercooler tubes (30), and intercooler 0-rings (18) prevent the coolant from escaping around the outside of the cylindrical intercooler tubes (30). The combination of intercooler O-rings (18) and plugs (31) force the coolant water circulation to flow through the axial intercooler coolant channels (33). Specifically, coolant water flows from the end cap internal coolant jacket (25) into each intercooler core's coolant inlet (32), then along the axial intercooler coolant channels (33). While in those channels, the coolant absorbs heat gathered by the intercooler air channel fins (35). The heated coolant then passes out through the intercooler core coolant outlet (34) and into the end cap internal coolant jacket (24). From there it passes into the end cap coolant outlet (21) and into a coolant hose (47) which takes it to a coolant tank (45). The coolant is stored there until required, at which time it is drawn through a coolant hose (47) to the coolant pump (50) and begins a new circulation circuit. A conventional recovery hose (48) protects the system from excessive pressure. A coolant filler (46) allows introduction of additional coolant as necessary.

The unique aspect of the presented design is in the construction and placement of the main component of the intercooler, its core. The core consists of a rigid cartridge with a series of bores, arranged in a slightly arched configuration. Each cartridge bore contains a large diameter cylinder, through the wall of which run small tubes which carry the liquid coolant. The compressed induction air flows around the conjoined cartridges, rather than being forced through a flat cooling panel. This design significantly increases the amount of surface presented to the compressed air for cooling purposes.

The increased area may be readily demonstrated mathematically. Assume the cramped underhood quarters limit the space available for intercooling purposes to an area 18″×18″. The flat panel area limit is therefore 18×18=324 square inches. Now assume that using the preferred embodiment, the space is filled with six cylindrical intercooler cores, each 18″ long and 2.5″ in diameter (deducting half an inch from the diameter of each core to allow space for the walls of the cartridge). The formula for the side surface area of a cylinder is 2(pi) times radius times height, so approximating pi as 3.14, the area presented by each cylinder is 2×3.14×1.25×18=141.3 square inches. Six of those cylinders side by side present 141.3×6=848 square inches of heat-absorbing surface area. The presented design offers two and a half times as much heat-absorbing surface in the same space as a conventional design.

Another advantage of the cartridge construction and the cylindrical intercooler core design is that the number of cartridges can be easily increased or decreased to accommodate heightened cooling requirements, or space constraints. The preferred embodiment illustrated shows six, but the number of heat absorption cartridges can be as few as one or as many as the space allows, and may be made thinner by the use of a greater number of cores of lesser diameter. The cores could be arranged in two or more offset rows vertically, if horizontal space constraints are pressing. The compact and easily modified nature of the intercooler construction makes it readily adaptable to numerous applications, both as original equipment manufacture and as an aftermarket addition.

Another advantage of the cartridge and symmetric end cap design is that it speeds assembly and installation, and thus may be expected to lower production costs and make the invention easier for sports car enthusiasts to install themselves.

An intercooler and plenum assembly constructed in accordance with a preferred embodiment of the present invention has few sealing surfaces. Its outer casing can be made up of as few as only one top piece, one bottom piece, and two end pieces. It does not require separate sealing surfaces for the intercooler coolant flow. Therefore, the preferred embodiment has a high air sealing efficiency and is simple, reliable, and easy to maintain or repair.

Those skilled in the art will appreciate that various adaptations and modifications of the described embodiments can be configured without departing from the scope and spirit of the invention. Indeed, one of the advantages of the invention is that it may be readily modified to fit various engine types. Therefore, it should understood that, within the scope of the claims, the invention may be practiced other than as specifically described herein. For example, the number of intercooler cartridges may be varied as necessary for cooling performance, increased for greater charge cooling effect, decreased where space considerations dictate and/or where the cooling requirements are lesser. In addition, a supercharger or turbocharger with an intercooler constructed in accordance with an embodiment of the present invention can be installed on other types of engines in different applications, e.g., an inline gasoline engine, a diesel engine, a stationary engine, a boat engine, etc. Furthermore, those phrases describing the orientation or directions, e.g., up, down, above, below, front, rear, top, bottom, are used in the specification for the ease of describing the various embodiments of the present invention with reference to the drawings. These phrases are not intended to impose any limitation on the scope of the present invention. The present invention can be practiced with superchargers or turbochargers with different orientations.

### DISCUSSION OF PRIOR RELATED ART

U.S. Pat. No. 6,311,676 (Nov. 6, 2001) granted to Oberg and Woodward, entitled “Intercooler Arrangement for a Motor Vehicle Engine,” describes the use of a single cylindrical intercooler core in a housing. The Oberg patent does mention in passing that two or more cores in parallel may provide further cooling. However, the Oberg patent makes claim only for a single intercooler core design. Moreover, the use of multiple cores for additional cooling is not only obvious, it is mentioned in the advertising of Laminova (see attachment), the supplier of the core of the Oberg patent also. The patent does not describe in any detail an advantageous arrangement of multiple cores. The patent does not describe the design for a multicore cartridge with simplified end cap mounting set forth in the instant patent application.

U.S. Pat. No. 6,347,618 (Feb. 19, 2002), granted to Richard Klem, entitled “Intercooler System for Internal Combustion Engine,” describes an intercooler arrangement using an air conditioner with a flat plate heat exchanger. Klem does suggest a possible embodiment using a second intercooler atop the first, using conventional water-based coolant. Klem differs from the instant application in its use of mechanical refrigeration as the coolant. Klem further differs in suggesting the potential use of two stacked flat plates cooling the same air stream twice, rather than multiple cylindrical cooling cores arranged in parallel cooling the air stream once. Klem further differs in failing to discuss in any detail the intercooler case or the method of mounting the cooling surfaces.

U.S. Pat. No. 4,823,868 (Apr. 25, 1989), granted to Dennis Neebel, entitled “Intercooler and Method of Assembling the Same,” describes an intercooler with a highly compressible seal pressed between intercooler housing and core. The illustrated application of Neebel uses a simplified casing. However, Neebel makes no claim for the design of the casing, other than the use of a mounting flange on the intercooler core to which the case is bolted. This application is completely different from the case and core design presented here. Nor does Neebel use cylindrical cooling cores, nor a cartridge and end cap mounting system.

U.S. Pat. No. 4,436,145 (Mar. 13, 1984), granted to Joseph Manfredo and Selwyn Hirsch, entitled “Charge Air Cooler Mounting Arrangement,” describes a charge air cooler utilizing multiple flat heat transfer elements sandwiched in parallel and separated by dividing plates, in a compact case designed to fit inside an existing intake manifold. Manfredo differs from the instant application in its use of the existing intake manifold; the present application replaces the intake manifold on existing engine designs. In Manfredo, the air flow runs along the flat plates, not through or across them. The plates separating the cooling elements serve no structural purpose. This application is completely different from the case and core design presented here, where the elements separating the cooling elements are structural. Nor does Manfredo use the advantageous cylindrical cooling cores, nor a cartridge and end cap mounting system.

U.S. Pat. No. 6,098,576 (Aug. 8, 2000), granted to Theodore Nowak, Jr. et al., entitled “Enhanced Split Cooling System,” describes a cooling system stacking horizontally in parallel heat exchanging plates for the engine radiator, an oil subcooler, and an intercooler subcooler, and with a complex piping and valve system allowing multiple switching modes to alter the cooling profile. Nowak differs from the instant application in the lack of discussion of mode of assembly, lack of use of cylindrical cores, the stacking of flat plate cores handling dissimilar fluids, and the absence of a cartridge and end cap assembly method.

1. A method for cooling the temperature of a source of air for induction into an internal combustion motor vehicle engine, comprising:
a compressor module;
a casing which contains a plenum between the compressor module and an intercooler with multiple air passages; and another plenum gathering the induction air from the intercooler and distributing it to a series of intake runners, there being at least one intake runner running from this second plenum to at least one cylinder of an internal combustion engine;
end caps on the casing;
an intercooler; and
runners that conduct air from the casing to the individual engine intake air ports.

2. The method for cooling the temperature of a source of air for induction into an internal combustion motor vehicle engine of claim 1, wherein the intercooler comprises:
a rigid arched hollow housing with a number of evenly-spaced cylindrical bores, into which fit individual coolant cores; and
a series of intercooler cores, each in the shape of a regular cylinder, one designated for and sized to fit tightly in each bore in the housing.

3. The method for cooling the temperature of a source of air for induction into an internal combustion motor vehicle engine of claim 2, wherein said housing defines an intake side with ports in each bore opening to each cylindrical intercooler bore, and an outlet side opposite in each bore with ports opening to each intercooler bore.

4. The method for cooling the temperature of a source of air for induction into an internal combustion motor vehicle engine of claim 3, wherein:
each intake port is shaped as a long slot, along the intake side of each bore (14), running along the axis of said bore, and allowing said bore to be open to the intake side of the intercooler housing; and
each outlet port is shaped as a long slot along the outlet side of each bore (15), running along the axis of said bore, and allowing said bore to be open to the outlet side of the intercooler housing.

5. The method for cooling the temperature of a source of air for induction into an internal combustion motor vehicle engine of claim 2 further utilizing a series of identical intercooler cores, said cores being in the shape of a regular cylinder, each comprising:
hollow walls with multiple tubular passages running axially for the conduction of liquid coolant through the walls for the length of the core; and
multiple thin raised fins, suitable for absorption of heat from air, running radially around the outer circumference of each core.

6. The method for cooling the temperature of a source of air for induction into an internal combustion motor vehicle engine of claim 1, wherein said end caps are symmetrical, and each cap containing:
machined flanges and seats on the face mounted to the case adapted to capture the ends of the intercooler housing of claim 2 and the intercooler cores of claim 6;
an internal jackets adapted to allow coolant passage; and
an inlet or outlet adapted to allow coolant passage.

7. The method for cooling the temperature of a source of air for induction into an internal combustion motor vehicle engine of claim 2, wherein the arrangement of multiple cylindrical cooling cores held in a rigid arched casing allows the airflow to be exposed to considerably more heat absorbing surface when contrasted to conventional flat panel intercooler designs.

8. The method for cooling the temperature of a source of air for induction into an internal combustion motor vehicle engine of claim 7, wherein the arrangement of multiple cores held in a rigid arched casing provides significantly enhanced reduction of temperature of intake charge airflow when contrasted to flat panel intercooler designs.

9. The method for cooling the temperature of a source of air for induction into an internal combustion motor vehicle engine of claim 8, wherein the reduction of temperature of intake charge airflow when contrasted to flat panel intercooler designs enhances engine thermal efficiency, and thus power.

10. The method for cooling the temperature of a source of air for induction into an internal combustion motor vehicle engine of claim 6, wherein the arrangement may readily be modified to include a greater or lesser number of the cores identified in claim 5, to meet varying cooling and space requirements for different internal combustion engines.

11. The method for cooling the temperature of a source of air for induction into an internal combustion motor vehicle engine of claim 2, wherein the use of modular assembly components simplifies the installation of supercharger s in both original equipment applications, and as an aftermarket kit.

12. The method for cooling the temperature of a source of air for induction into an internal combustion motor vehicle engine of claim 1, further comprising: casting a first metal element to integrally form the first section of the intake air path, the lower plenum, the upper plenum, the first section of the air outlet paths to each cylinder; casting a second metal element to integrally form the second section of the air path from the upper plenum to the individual engine cylinders; and fastening the first metal element and the second metal element together with a sealing surface there between.

13. The method for cooling the temperature of a source of air for induction into an internal combustion motor vehicle engine of claim 1, wherein the construction of the casing with a minimal number of sealing surfaces minimizes the likelihood of air leaks.
